(19) United States
(12) Patent Application Publication
(10) Pub. No.: US 2017/0171273 A1
(43) Pub. Date: Jun. 15, 2017

(54) REDUCING STREAMING CONTENT INTERRUPTIONS

(71) Applicant: Lenovo (Singapore) Pte. Ltd., Singapore (SG)

(72) Inventors: Russell Speight VanBlon, Raleigh, NC (US); Nathan J. Peterson, Oxford, NC (US); Rod D. Waltermann, Rougemont, NC (US); John Carl Mese, Cary, NC (US); Arnold S. Weksler, Raleigh, NC (US)

(21) Appl. No.: 14/964,181

(22) Filed: Dec. 9, 2015

(51) Int. Cl. H04L 29/06; H04L 29/08

(52) U.S. Cl. CPC H04L 65/601; H04L 67/2842

(57) ABSTRACT

One embodiment provides a method including: streaming a wireless content stream utilizing a cache of a first cache size; identifying, using a processor, an impending data availability context associated with an interruption in the wireless content stream; and adjusting, based on the identifying, the cache of the wireless content stream to a second cache size. Other aspects are described and claimed.

### BACKGROUND

The prevalence and portability of information handling devices (e.g., smart phones, tablets, personal computers, laptop computers, etc.) allows users to use these devices to provide and accept input in a variety of locations. For example, an individual may use a smart phone to stream music while traveling from one location to another. As another example, a passenger in a vehicle may use a tablet to browse websites on the internet. Users often stream content via a wireless wide area network (WWAN) connection provided by a telecom network. For example, a user may wirelessly stream digital content using the mobile carrier towers that are instituted and maintained by a user's wireless communications service provider.

While traveling, digital content streams can become interrupted. One reason for this is because a user has traveled into a coverage gap between carrier towers. Another reason is because various physical obstacles (e.g., trees, buildings, tunnels, etc.) temporarily block the wireless signal. This can lead to user frustration due to stopped or stuttered content playback. Therefore, it would be desirable if the frequency of content interruptions were limited.

### BRIEF SUMMARY

In summary, one aspect provides a method comprising: streaming a wireless content stream utilizing a cache of a first cache size; identifying, using a processor, an impending data availability context associated with an interruption in the wireless content stream; and adjusting, based on the identifying, the cache of the wireless content stream to a second cache size.

Another aspect provides an electronic device, comprising: a processor; a memory device that stores instructions executable by the processor to: stream a wireless content stream utilizing a cache of a first cache size; identify an impending data availability context associated with an interruption in the wireless content stream; and adjust, based on the identifying, the cache of the wireless content stream to a second cache size.

A further aspect provides a product, comprising: a storage device that stores code executable by a processor, the code comprising: code that streams a wireless content stream utilizing a cache of a first cache size; code that identifies an impending data availability context associated with an interruption in the wireless content stream; and code that adjusts the cache of the wireless content stream to a second cache size.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of reducing streaming content interruptions.

FIG. 4 illustrates an example of a coverage gap between two coverage towers.

FIG. 5 illustrates an example of two users operating devices with differing bandwidths in relation to a data availability edge.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

The increased functionality of portable information handling devices (“devices”) has allowed more flexibility for users. For example, mobile users can now perform a variety of functions on their devices such as stream music and videos, browse websites, navigate using GPS services, etc. However, in order to perform these functions, the user's device needs to be connected to a wireless network in order to attain internet access.

One current method to assist in connecting users to a wireless network involves a subscription by a user to a data plan provided by a wireless communications service provider. The wireless WAN is maintained over large coverage areas through the use of numerous cellular coverage towers instituted by the wireless service providers. When in the coverage area of a nearby coverage tower, a subscribed user can pick up the wireless signal and attain internet access. However, when a user is moving frequent interruptions may occur while streaming digital content. For example, a user may enter a coverage gap, or “dead zone,” in between cellular towers where they do not receive a strong enough signal to access the wireless network. In another example, various obstacles such as trees, mountains, tunnels, large buildings, etc., that the user is in proximity with may block or weaken the wireless signal. Such cases may lead to user frustration due to stopped or stuttered content playback as well as an inability to access additional content.

These technical issues present problems for users in that limiting the frequency of content interruptions on a device while traveling may be difficult. A conventional solution is to statically increase the cache from the service (e.g., video content provider, music content provider, etc.) a user is streaming the content from. However, this will use unnecessary data if the user skips content, for example, by changing songs, changing content providers, and the like. Additionally, statically increasing the cache from the service could result in unnecessary data usage and charges. For example, if the largest cache size is always selected, every time a song changes the device downloads a large amount of data even if the user decides to skip the song or play something else. This could result in wasted data for both the streaming service servers as well as the user's data plan. Another solution is for the user to pre-cache all of the content they wish to access later on their device. However, this is inconvenient and requires a lot of planning and storage.

Accordingly, an embodiment provides a method for reducing streaming content interruptions on an electronic device (e.g., laptops, smart phones, tablets, etc.) while moving. Using this method, the caching method on a device may be dynamically changed based on wireless data coverage. One embodiment may pre-cache enough data to last the user during the dead zone between coverage areas when a user is about to switch towers or encounter a coverage gap. For example, when streaming audio while driving, the streamed content may frequently skip due to changing towers and coverage gaps. In an embodiment, a device may temporarily increase its buffer before entering a dead zone or when changing towers. The upcoming song (or other media type) may then be pre-cached and may play without interruption even after entering an area where no signal is received.

An embodiment may detect when a user is moving and is likely to approach the edge of a coverage area, i.e., a data availability edge, through multiple methods. An embodiment may detect when a user is nearing the edge of a coverage area by storing, on the device, carrier coverage map data as well as data related to upcoming road obstacles (canyons, tall buildings, tunnels, etc.). With this information, a device may detect when it is approaching a data availability edge and may be able to predict how long it will be until the user returns to an area with stronger signal coverage. When approaching a detected edge, an embodiment may increase the cache size to download enough content to occupy the user for the duration of the coverage outage. The determination of how much to increase the cache size by may be based on a variety of routing factors. An embodiment may also detect the edge of a coverage area by detecting when the wireless signal strength falls below a predetermined threshold. Based on the detection, an embodiment may increase the cache size enough to play content for a period of time after leaving the coverage area.

In an embodiment, the cache size may also be increased based upon the overall data bandwidth available. If the overall bandwidth is reduced, it may affect a device's ability to quickly pre-cache content. Therefore, if the bandwidth goes down, an embodiment may increase the cache size or buffer based upon how long it may take to reach the edge of the data coverage area.

The illustrated example embodiments will be best understood by reference to the figures. The following description is intended only by way of example, and simply illustrates certain example embodiments.

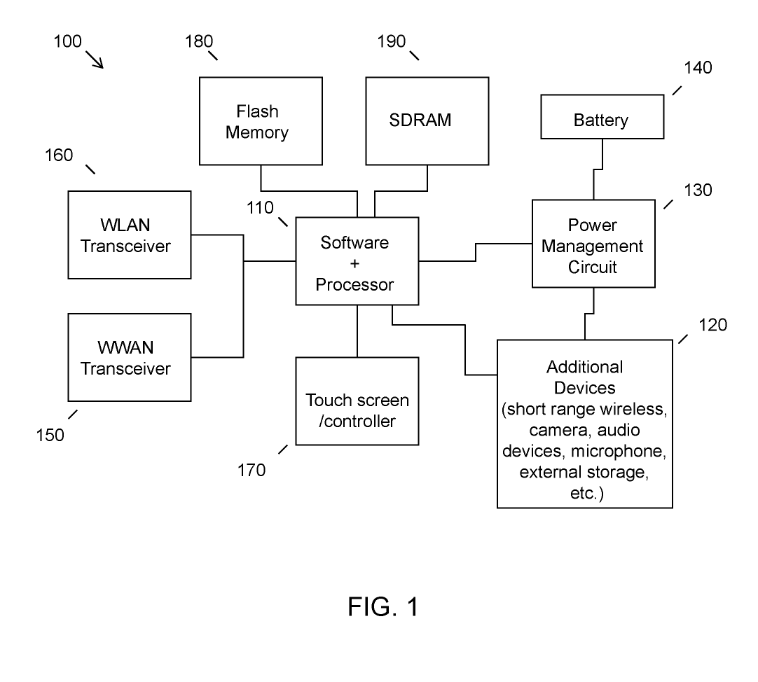

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera. System 100 often includes a touch screen or touch surface 170 for data input and display/rendering. System 100 also typically includes various memory devices, for example flash memory 180 and SDRAM 190.

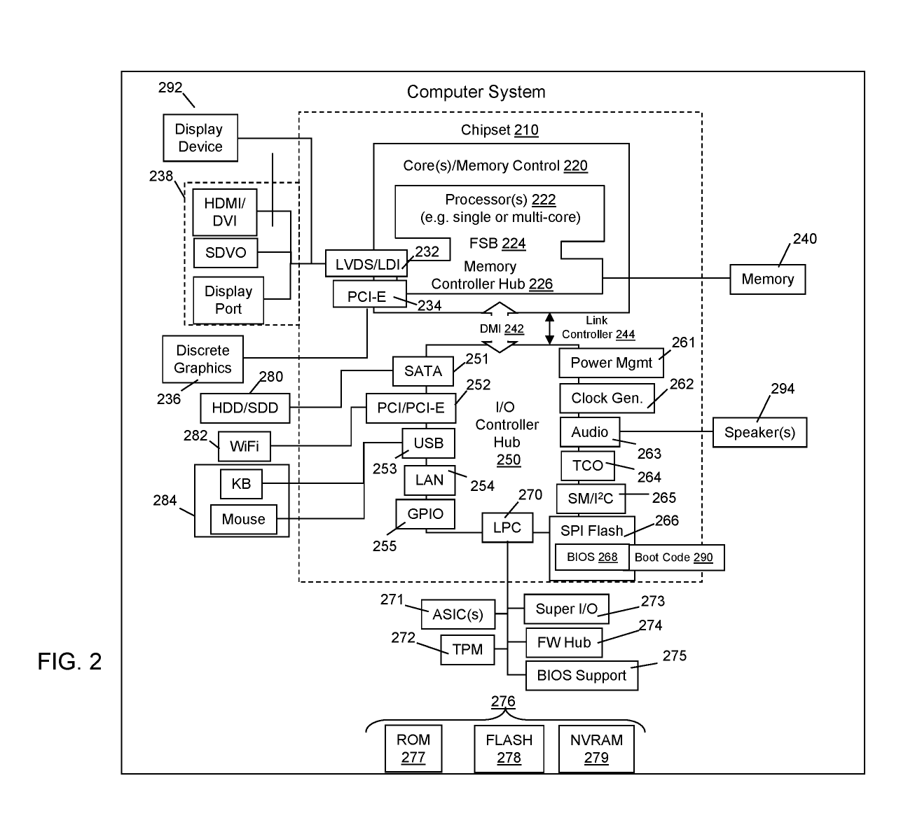

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or other mobile electronic devices which users may use to stream content. For example, the circuitry outlined in FIG. 1 may be implemented in a tablet or smart phone embodiment, whereas the circuitry outlined in FIG. 2 may be implemented in a personal computer embodiment, e.g., a laptop personal computer.

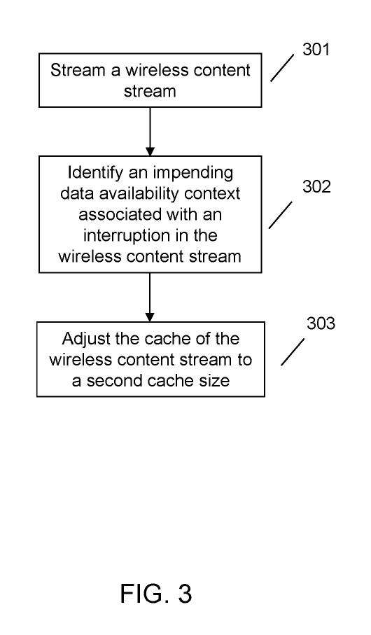

Referring now to FIG. 3, at 301, an embodiment may stream a wireless content stream. The content available to be streamed may include, but is not limited to, music, podcasts, and video.

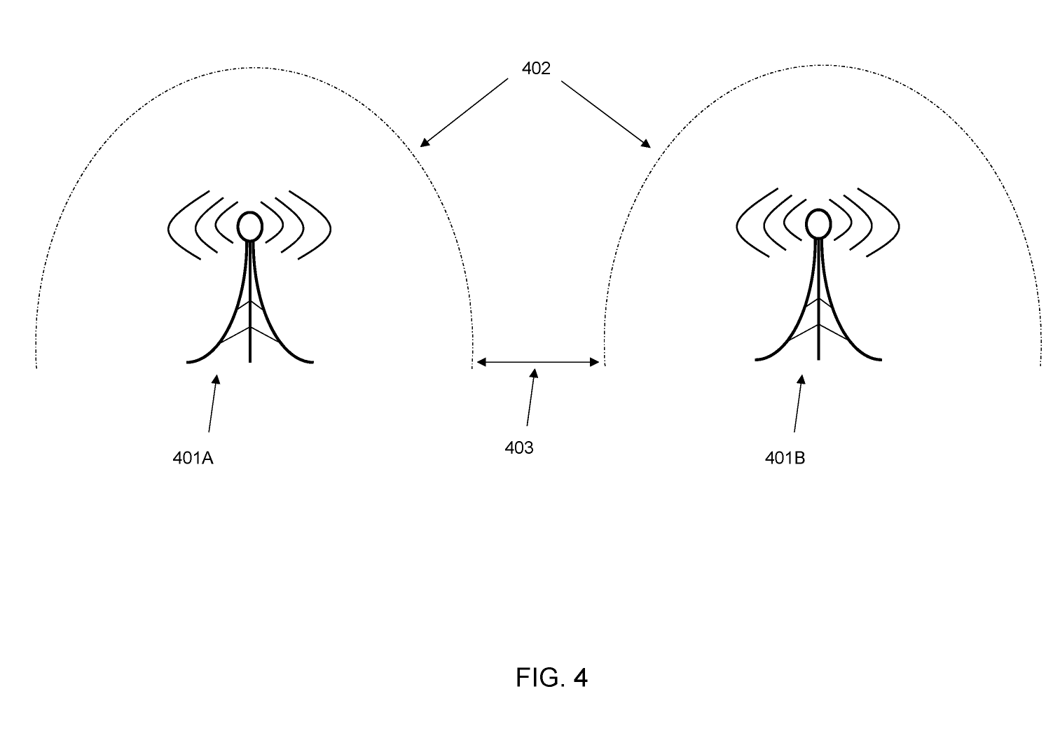

At 302, an embodiment may identify an impending data availability context. A data availability context may include, but is not limited to, a coverage gap in between coverage towers, physical obstacles (e.g., trees, buildings, tunnels, mountains, etc.), historical travel data, or an area of high network congestion. A data availability edge may represent the point in a wireless coverage area beyond which a user may lose connection to the wireless network and experience an interruption in a wireless content stream. As an example, FIG. 4 depicts two coverage towers 401(A-B) and their respective wireless coverage areas 402. A coverage gap 403 is depicted between the wireless coverage areas 402. The coverage gap 403 represents the location where the wireless signal strength may be low or non-existent.

An embodiment may identify an edge by utilizing the information provided by a carrier coverage map. These maps may identify areas of strong and weak wireless coverage over a service provider's entire coverage area. The map can be stored on the device, in the cloud, may be accessed online, and the like. One embodiment may identify physical obstacles by using topographic information provided by a global positioning system (GPS). If a carrier coverage map or GPS is unavailable, an embodiment may identify an edge by detecting when the wireless signal strength falls below a predetermined threshold. For example, if the wireless signal strength falls below seventy-five percent, a device may determine that the device is approaching an edge because the wireless signal strength is decreasing. The predetermined threshold may be a default value or may be defined by a user.

An embodiment may predict how long an interruption in the wireless content stream will last. In one embodiment the prediction may be based on an analysis of one, or a multitude of, routing factors. Examples of routing factors include, but are not limited to, size of the coverage gap, current speed, estimated future speed including potential stops, time needed for data re-negotiation, and the content bit rate. One embodiment may predict how long an interruption will last based on historical data. For example, if a user traverses the route frequently, an embodiment may utilize the route traversal information to identify how long the device is normally within a coverage gap. Alternatively, the prediction may be based upon a predefined value. For example, a user may indicate or set a specified time or duration of the interruption.

An embodiment may determine an amount a system cache needs to be increased by to prevent an interruption in the wireless content stream. As an example, if a song is being played and an approaching data availability edge is detected, the caching algorithm may be adjusted to pre-cache enough data to last the duration of the coverage gap. The calculation may be based on information provided by one or more routing factors and other factors. For example, a caching algorithm may take into account the rate of media consumption (e.g., the rate at which the user consumes the data), for example based on media type, application type, user history, etc. The amount may also be predefined by a user or content provider.

At 303, an embodiment may adjust the cache size of the wireless content stream. In an embodiment, after a data availability edge is detected and a system determines how much data needs to be pre-cached to last a user during the duration of a wireless signal outage, the system cache size may be increased to accommodate the additional data. Downloading additional data from a data stream before reaching a data availability edge may minimize the interruptions a user may experience in a content stream while traveling through a dead zone. For example, while listening to a music streaming service, pre-caching an upcoming song before reaching an edge minimizes interruptions in the music stream. If the user is performing an internet search, additional websites may also be pre-cached. For example, if an internet search is performed an embodiment may pre-cache the first five results and websites associated with those results so that the user may access any of the sites even if no wireless signal is available. The number of websites pre-cached may be a default number, may be determined by a user, may be based on the user's data plan, may be determined by signal strength, and the like.

In an embodiment, when a data availability edge is detected, a cache size may be set to increase by a predetermined amount. For example, when an edge is detected based upon information provided by a carrier coverage map, a cache is increased by ten megabytes. In an embodiment, a device may be set to start caching additional content at a predetermined distance or time from the data availability edge. For example, when an edge is detected based upon information provided by a carrier coverage map, the device may start caching additional content when the user is two miles away from the edge. In an embodiment, a cache size may be set to increase by a predetermined amount once the wireless signal strength falls below a predetermined threshold. For example, when the wireless signal strength falls below seventy-five percent, a system cache is increased by five megabytes. In an embodiment, the cache size may be set to increase by a predetermined amount based upon the rate at which the wireless signal strength decreases. For example, when the signal strength drops from ninety percent to sixty percent over the course of one mile (i.e., signal rate loss of thirty percent per mile), a cache is increased by two megabytes.

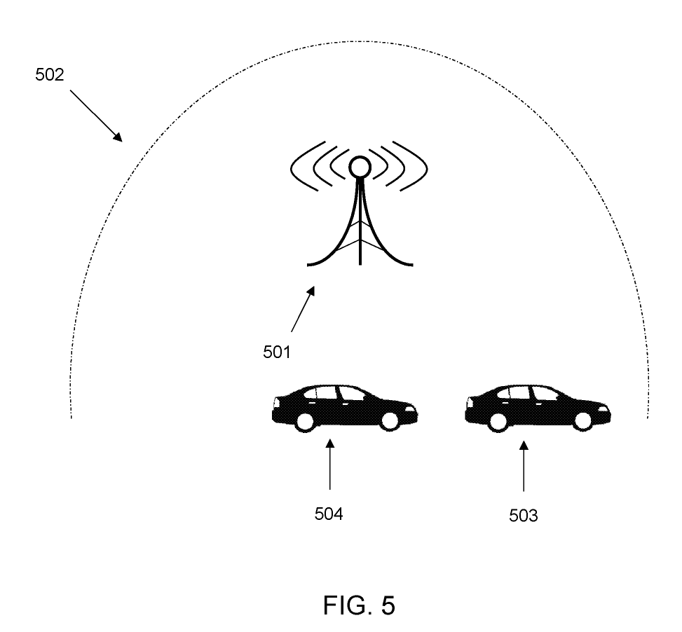

In an embodiment, a system cache size may be increased based on the overall data bandwidth available. If overall bandwidth is reduced, it may change a user's ability to quickly pre-cache content. Therefore, when bandwidth decreases, an embodiment may increase the cache or buffer based on how long it would take to reach a data availability edge. For example, if a user's device is operating on a slower connection, then their ability to do a burst download may be impacted. Therefore, the device may begin downloading when the user is halfway to a data availability edge, as opposed to three quarters of the way, to make sure the desired content is pre-cached. As an example embodiment, referring to FIG. 5, a coverage tower 501 with a wireless coverage area 502 is depicted. A driver with a device operating at a fast bandwidth 503 may start their download closer to the edge. However, a driver with a device operating at a slow bandwidth 504 may start their download much earlier to ensure that they will download all of the desired data.

An embodiment may be implemented at the operating system (OS) level. For example, the OS provides approaching edges to all applications. An embodiment could also be implemented within a single application, as long as that application has access to data used to determine an approaching edge, e.g., a carrier data map and/or wireless signal strength data. In an embodiment, a user can choose the basis for determining that a cache size should be increased, the amount they want the cache size to be increased by, and when they want the device to start increasing the cache. These settings can be changed on the device or can be changed remotely.

The various embodiments described herein thus represent a technical improvement to conventional data streaming techniques. Using the techniques described here, an embodiment provides an automated adjustment to data streaming rates. Additionally, rather than the user having to suffer a delay or drop in performance, an embodiment allows a user to stream media even though gaps in network availability may be encountered.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, etcetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
streaming a wireless content stream utilizing a cache of a first cache size;
identifying, using a processor, an impending data availability context associated with an interruption in the wireless content stream; and
adjusting, based on the identifying, the cache of the wireless content stream to a second cache size.

2. The method of claim 1, wherein the impending data availability context is identified using data selected from the group consisting of: data indicating a coverage gap, data indicating a physical obstacle, historical data, and data indicating a congested network.

3. The method of claim 2, wherein the data indicating a coverage gap comprises data from a carrier coverage map.

4. The method of claim 1, further comprising predicting, using a processor, how long the interruption will last.

5. The method of claim 4, wherein the predicting is based on at least one routing factor selected from the group consisting of: a size of the coverage gap, a current travel speed, an estimated future travel speed, an estimated route of travel, a time needed for data re-negotiation, and a content bit rate.

6. The method of claim 1, wherein the adjusting comprises increasing the cache of the wireless content stream.

7. The method of claim 1, further comprising predicting, using a processor, how long the interruption will last; and
determining, based on the predicting, an amount to increase the cache of the wireless content stream to prevent interruption.

8. The method of claim 1, wherein the adjusting comprises increasing the cache size at a predetermined parameter from the impending data availability context associated with an interruption in the wireless content stream; and
wherein the parameter is one or more of time and distance.

9. The method of claim 1, wherein the identifying comprises comparing wireless data transmission to a predetermined threshold.

10. The method of claim 9, wherein:
the predetermined threshold is a data transmission rate; and
the adjusting comprises increasing the cache size based on the data transmission rate.

11. The method of claim 9, wherein:
the predetermined threshold is a data consumption rate; and
the adjusting comprises increasing the cache size based on the data consumption rate.

12. An electronic device, comprising:
a processor;
a memory device that stores instructions executable by the processor to:
stream a wireless content stream utilizing a cache of a first cache size;
identify an impending data availability context associated with an interruption in the wireless content stream; and
adjust, based on the identifying, the cache of the wireless content stream to a second cache size.

13. The electronic device of claim 12, wherein the impending data availability context is identified using data selected from the group consisting of: data indicating a coverage gap, data indicating a physical obstacle, historical data, and data indicating a congested network.

14. The electronic device of claim 12, wherein the instructions are further executable by the processor to predict how long the interruption last.

15. The electronic device of claim 14, wherein to predict is based on at least one routing factor selected from the group consisting of: a size of the coverage gap, a current travel speed, an estimated future travel speed, an estimated route of travel, a time needed for data re-negotiation, and a content bit rate.

16. The electronic device of claim 12, wherein to adjust comprises increasing the cache of the wireless content stream.

17. The electronic device of claim 12, wherein the instructions are further executable by the processor to predict how long the interruption will last; and
to determine an amount to increase the cache of the wireless content stream to prevent interruption.

18. The electronic device of claim 12, wherein to adjust comprises increasing the cache size at a predetermined parameter from the impending data availability context associated with an interruption in the wireless content stream.

19. The electronic device of claim 12, wherein to identify comprises comparing wireless data transmission to a predetermined threshold.

20. A product, comprising:
a storage device that stores code executable by a processor, the code comprising:
code that streams a wireless content stream utilizing a cache of a first cache size;
code that identifies an impending data availability context associated with an interruption in the wireless content stream; and
code that adjusts the cache of the wireless content stream to a second cache size.
